(19) United States
(12) Patent Application Publication
(10) Pub. No.: US 2026/0346499 A1
(43) Pub. Date: Nov. 5, 2026

(54) WAX FORMWORK PRODUCTION DEVICE AND METHOD FOR PRODUCING A WAX FORMWORK

(71) Applicants: TECHNISCHE UNIVERSITÄT BRAUNSCHWEIG, Braunschweig (DE); HERRHAMMER GMBH SPEZIALMASCHINEN, Ochsenfurt (DE)

(72) Inventors: Sven JONISCHKIES, Braunschweig (DE); Norman HACK, Braunschweig (DE); Harald KLOFT, Frankfurt (DE); Jeldrik MAINKA, Braunschweig (DE); Ralf DIESSLIN, Würzburg (DE)

(21) Appl. No.: 19/120,366

(22) PCT Filed: Oct. 6, 2023
(86) PCT No.: PCT/EP2023/077722

§ 371 Date: Apr. 11, 2025

(30) Foreign Application Priority Data
Oct. 11, 2022 (DE) 10 2022 126 252.9

(51) Int. Cl. B28B 7/34; B33Y 10/00; B33Y 30/00; B33Y 80/00

(52) U.S. Cl. CPC B28B 7/346; B33Y 10/00; B33Y 30/00; B33Y 80/00

(57) ABSTRACT

The invention relates to a wax formwork production device for producing a wax formwork for concrete casting with a melting unit for heating the wax to a predeterminable temperature above a solidification temperature of the wax, a mixing unit that is configured to mix gas into the wax, resulting in a wax-gas mixture, a nozzle that is arranged downstream of the mixing unit in the direction of flow and is configured to apply the wax-gas mixture in layers to a substrate, a positioning system positioning the nozzle relative to the substrate, and a control unit that is configured to control the positioning system for positioning the nozzle relative to the substrate such that the wax formwork is created.

The invention relates to a wax formwork production device for producing a wax formwork for concrete casting. According to a second aspect, the invention relates to a method for producing a wax formwork for concrete casting. Furthermore, the invention relates to a concrete casting manufacturing facility as well as a method for producing a concrete component.

Waxes are understood to mean both natural waxes and industrially manufactured waxes. This includes animal waxes, vegetable waxes, mineral waxes, petroleum waxes, and synthetic waxes. Waxes are normally kneadable at 20 °C, solid to brittle hard, coarse to fine crystalline, translucent to opaque, but not glassy, they melt above 40 °C without decomposing, have relatively low viscosity even slightly above the melting point, their consistency and solubility are strongly dependent on temperature, and are polishable under slight pressure.

A formwork is a surface-sealing, usually temporary component that serves as a support for the concrete until it hardens, which makes it possible to produce concrete components in the desired shape within the selected production tolerances. The production of precise, free-formed concrete components usually requires special formworks. These are usually made of wood, acrylonitrile-butadiene-styrene copolymers (ABS), polylactides (PLA), polyvinyl alcohol (PVAL or PVOH), polyurethane (PU) or polystyrene (PS). In most cases, the formwork material cannot be recycled because of the coating required. In addition, the tolerance deviations of most special formworks for the production of precision finished parts are unsatisfactory.

The task of the present invention is to avoid the disadvantages of the prior art.

The invention solves this problem by way of a wax formwork production device for producing a unit for heating the wax to a predeterminable temperature above the solidification temperature of the wax, (b) a mixing unit which is configured to mix gas into the wax such that a wax-gas mixture is produced, (c) a nozzle which is arranged downstream of the mixing unit in the direction of flow and is configured to apply the wax-gas mixture in layers to a substrate, (d) a positioning system for positioning the nozzle (30) relative to the substrate, and (e) a control unit which is designed to control the positioning system for positioning the nozzle relative to the substrate such that the wax formwork is produced.

The invention is based on the finding that the gas inclusions in a wax formwork made from a wax-gas mixture mean that the wax formwork shrinks less during and after production and thus also exhibits less warping. In other words, the dimensional accuracy of the wax formwork can be very high. The gas inclusions also mean that, due to the thermally insulating effect of the gas inclusions, the wax formwork is heated less intensely when the wax formwork is exposed to the hydration heat of the concrete during production of a concrete component. This also favors the strength of the wax formwork during concrete component production. It is also advantageous that the material consumption of wax is reduced by the use of a wax-gas mixture.

A further advantage is that the wax formworks are both ecological and very economical due to the fact that the wax can be reused by melting it down. The wax formworks generated using the wax formwork production device according to the invention do not exhibit any fissures or cavities. They are also very stable, making the wax formworks particularly suitable for the manufacture of concrete components made of Ultra High Performance Concrete (UHPC).

In particular, a substrate is understood to be a base plate, a deposited wax-gas mixture or a base body to be printed onto. A gas is understood to be a pure substance, particularly carbon dioxide, or a gas mixture, particularly air.

Preferably, the glass transition temperature of the wax is above 40 °C. Preferably, the solidification temperature of the wax is above 50 °C, particularly preferably above 60 °C. The solidification temperature can be determined in accordance with DIN ISO 2207.

Preferably, the compressive strength of the wax at 20 °C is more than 0.25 N/mm².

Advantageously, the compressive strength of the wax-gas mixture at 20 °C is at least half of the compressive strength of the wax at 20 °C. The modulus of elasticity of the wax is preferably more than 25 N/mm² under compressive load at 20 °C, preferably more than 500N/mm², in particular more than 1000N/mm², particularly preferably more than 2000N/mm². Preferably, the drop point of the wax is above 80 °C, particularly above 150 °C.

It may be provided for that a wax consisting of a renewable raw material can be used. In particular, it can be provided for that the wax comprises exclusively renewable raw materials. It is also conceivable that the wax consists of at least 50%, in particular 90%, preferably 100% renewable raw material. Renewable raw materials for the wax can be, for example, vegetable waxes such as soy wax, palm oil wax, coconut oil wax and/or rapeseed oil wax. This list is not to be considered exhaustive.

Preferably the gas and/or the wax-gas mixture contain a filler, especially a mineral and/or organic filler. Alternatively or additionally, the mixing unit is configured to add a filler, especially a mineral and/or organic filler, to the wax and/or the wax-gas mixture. Calcium silicate hydrate, calcium carbonate, limestone powder, talcum and/or raw cellulose can be used as fillers, for example. In particular, the filler is selected in such a way that it increases the compressive strength of the wax-gas mixture and/or at least improves a thermal and/or mechanical material property of the wax-gas mixture.

Preferably, the melting unit has or forms a heating element, in particular in the form of a heating cartridge, a heating band, a heat exchanger, a continuous flow heater, a heating medium, an immersion heater or similar.

A further development of the invention intends for the melting unit to be arranged in the mixing unit or upstream of the mixing unit in the direction of flow. If the melting unit is upstream of the mixing unit in the direction of flow, the melting unit preferably has an opening for receiving wax. If the melting unit is arranged in the mixing unit, the mixing unit preferably has an opening for receiving wax.

The mixing unit preferably has a gas inlet via which gas can be supplied. The gas inlet is preferably fluidically connected to a fan and/or a gas compressor. Alternatively or additionally, a nozzle is arranged on the gas inlet or the gas inlet forms said nozzle. The nozzle is preferably controllable. Preferably, the nozzle is connected to a pressure vessel that contains a compressed gas.

A conveyor tube is preferably arranged between the melting unit and the mixing unit and/or between the mixing unit and the nozzle. The conveyor tube is preferably heated. There is the option of arranging a conveyor device on the conveyor tube, said device being configured to support the movement of the wax and/or the wax-gas mixture through the conveyor tube. The conveyor device may have, for example, a pump, an extruder or a compressor. Alternatively or additionally, the movement of the wax can be supported by the pressure in the melting unit and/or in the mixing unit. There is also the possibility of arranging the melting unit and the mixing unit and/or the mixing unit and the nozzle in relation to each other in such a way that no conveyor tubes are required. To this end, the melting unit is preferably arranged in or above the mixing unit and the mixing unit above the nozzle, so that the movement of the wax and/or the wax-gas mixture is supported by gravity and no conveyor device is required. The melting unit, the mixing unit and the nozzle preferably have a common housing. The positioning system is preferably configured to accommodate the melting unit, the mixing unit and the nozzle, and to jointly position them relative to the substrate. The control unit is preferably configured to control the positioning system to jointly position the melting unit, the mixing unit and the nozzle relative to the substrate.

Preferably, the control unit is configured to adjust a mass flow of the nozzle. This is particularly advantageous if the movement speed of the nozzle relative to the substrate is changed and at the same time the strand width of the wax-gas mixture extruded through the nozzle in strand form is to remain the same. In addition, the mass flow can be set to zero when the position of the nozzle relative to the substrate is to be changed without an extrusion of the wax-gas mixture occurring at the same time. The control unit is preferably configured to control the conveyor device such that the mass flow at the nozzle corresponds to a predeterminable mass flow.

A further development of the invention envisages that the mixing unit comprises (a) a mixing chamber with a tempering surface, (b) a tempering device that is configured to temper the tempering surface to a tempering temperature so that the wax-gas mixture is tempered on the tempering surface of the mixing chamber, and (c) a scraping element for scraping the wax-gas mixture from a scraping wall of the mixing chamber and/or from the tempering surface of the mixing chamber. The scraping wall is preferably an outer wall of the mixing chamber. Preferably, the temperature of the wax and/or of the wax-gas mixture does not fall below the solidification temperature of the wax during tempering. Alternatively, the temperature of the wax and/or of the wax-gas mixture during tempering does not fall below a minimum temperature, which is preferably at most 20 °C, preferably at most 10 °C, particularly at most 5 °C, particularly preferably at most 2 °C below the solidification temperature of the wax. The mixing chamber is preferably designed to be rotationally symmetrical, particularly cylindrical. The mixing chamber may have an open side, which is preferably designed to be sealable.

The tempering surface preferably forms a scraping wall of the mixing chamber or a part of a scraping wall of the mixing chamber. In particular, the scraping wall may be an outer wall, a side wall and/or an inner wall of the mixing chamber.

Advantageously, the tempering surface forms an outer wall of the mixing chamber or part of an outer wall of the mixing chamber. The mixing unit preferably comprises a tempering device that is arranged on the tempering surface or forms said surface. The melting unit is preferably the tempering device. Alternatively or additionally, the tempering device may be a heating element and/or a cooling element, in particular a heating medium, a coolant, a heating band, a heat exchanger or a heating cartridge. The scraping element is preferably arranged in the mixing chamber such that it can be rotated about an axis of rotation.

Furthermore, it can be provided for that the device has a 2-step cooling system. In other words, in addition to the melting unit or the tempering device, the device can comprise a second tempering device. It can be provided for that the tempering device is further arranged in the mixing unit. In this case, it can be provided for that the wax-gas mixture is initially cooled down in the mixing unit by the tempering device. In particular, it can be provided for that the tempering device in the mixing unit cools the wax down to a temperature above a crystallization point. The crystallization point can be understood as the point at which a change from the amorphous-liquid state of the mixture to the crystalline state takes place. In other words, the temperature of the mixture at the crystallization point is above the temperature of the solidification point and below the temperature of the drop point. This has the advantage that it enables improved transport from the tempering device in the mixing unit to the nozzle and has sufficient stability to be placed on top of each other in layers.

It can be provided for that the second tempering device, which can be arranged in the nozzle, cools the wax-gas mixture to the crystallization point.

For example, it can be provided for that the wax in the mixing unit is melted and mixed with gas to form a wax-gas mixture, and cooled by means of the tempering device to a temperature above the crystallization point. The wax-gas mixture is then transported to the nozzle, where the wax-gas mixture is cooled further in the nozzle. Preferably, the wax-gas mixture in the nozzle is cooled to the crystallization point by the second tempering device. The tempering device may also comprise an optional heating element such that the wax-gas mixture can be heated to the crystallization point. In particular, the temperature of the wax-gas mixture at the nozzle is adjusted to the crystallization point by means of the second tempering device.

The scraping element is preferably designed as a mixing element that is configured to mix gas into the wax. Alternatively or additionally, a separate mixing element may be arranged in the mixing chamber. There is also the possibility of designing the mixing unit without a mixing element.

Mixing a predeterminable proportion of gas into the wax to create a wax-gas mixture can then be achieved, for example, by applying sufficient gas pressure in the mixing chamber.

The scraping element can be an agitator arm, for example, which is preferably designed correspondingly to the rotationally symmetrical and/or cylindrical mixing chamber. Preferably, the outer diameter of the agitator arm corresponds approximately to the inner diameter of the rotationally symmetrical and/or cylindrical mixing chamber.

Scraping is understood to mean a scraping removal from the surface or a scratching off. Part of the wax-gas mixture can also remain on the surface as residue.

Preferably, a minimum distance between the scraping wall of the mixing chamber and the scraping element during the rotation of the scraping element about the axis of rotation is at most 1 mm, preferably at most 0.1 mm, especially preferably at most 0.01 mm. Preferably, a maximum distance between the scraping wall of the mixing chamber and the scraping element during the rotation of the scraping element about the axis of rotation is at most 1 mm, preferably at most 0.1 mm, especially preferably at most 0.01 mm. The smallest possible distance between the scraping wall of the mixing chamber and the scraping element during rotation of the scraping element about the axis of rotation ensures that as little wax-gas mixture as possible remains on the scraping wall of the mixing chamber as residue during scraping of the wax-gas mixture.

The positioning system is preferably a robot, a portal system or a combination of the robot and the portal system. Preferably, the robot and/or the portal system comprises at least three axes, preferably at least four, especially at least five, especially preferably six, particularly preferably at least seven axes. The positioning system preferably comprises a fastening device or a gripper configured to accommodate a nozzle and/or a tool for machining. Preferably, the positioning system is configured to automatically pick up and/or automatically set down the nozzle and/or tool for machining.

A further development of the invention envisages that the wax formwork production device comprises (a) a cooler, which is arranged to cool previously deposited wax-gas mixture and/or (b) a heating device, which is arranged to heat up previously deposited wax-gas mixture. For example, a fan, a tube through which air flows with an outlet opening, a radiant heater and/or an infrared radiator can be provided as a cooler and/or heating device.

The cooler and/or heating device can preferably be oriented to a predeterminable angular position. The control unit is preferably designed to emit a control signal to the cooler and/or heating device such that the cooling of the cooler and/or the heating device is changed in such a way that the path of the cooler and/or the heating device is at a position in which the nozzle will be after a certain period of time has elapsed after the control signal has been sent. Alternatively or additionally, the cooler and/or the heating device is arranged on a separate positioning system, which is configured to move the cooler and/or the heating device into a position in which a position is located in the operating direction of the cooler/or heating device in which the nozzle will be located after a certain period of time has elapsed. A cooler means that the deposited wax-gas mixture can be cooled so that it is solid enough for a new wax-gas mixture to be applied onto the deposited wax-gas mixture.

A preferably provided heating device can be used to heat the deposited wax-gas mixture so that sufficient adhesion of the newly applied wax-gas mixture to the already deposited wax-gas mixture is ensured. The previously deposited wax-gas mixture is preferably not heated beyond the solidification temperature of the wax.

The mixing unit is preferably configured to add a predeterminable proportion of gas to the wax. Particularly preferably, the control unit is configured to automatically carry out a method comprising the steps: (a) detecting a target proportion of gas, (b) controlling the mixing unit such that a wax-gas mixture with a proportion of gas corresponding to the target proportion of gas forms when gas is added to the wax.

Preferably, the control unit also detects the position of the nozzle relative to the substrate and detects the target proportion of gas at this position. Alternatively or additionally, the control unit can read the large target proportion of gas from a CAM file or a CAM program.

The target proportion of gas for the production of contour surfaces is preferably smaller than for the production of support structures. Contour surfaces refer to surfaces that come into contact with the concrete during production of a concrete component. Support structures are understood to mean structures that are located in the component interior (infill) and/or that do not come into contact with the concrete during manufacture of a concrete component. The mixing unit preferably comprises a sensor for detecting the proportion of gas in the wax-gas mixture. Preferably, the control unit is configured to control the mixing unit as a function of sensor data. In particular, the mixing unit can be controlled by feedback from the sensor data.

The control unit is preferably configured to control the melting unit to heat the wax to a predetermined temperature above a solidification temperature of the wax.

The predeterminable proportion of gas in the wax-gas mixture and/or the actual proportion of gas in the wax-gas mixture is preferably at least 10% volume, preferably at least 20% volume. The predeterminable proportion of gas in the wax-gas mixture and/or the actual proportion of gas in the wax-gas mixture for the production of support structures is preferably at least 20% volume, preferably at least 40% volume.

Preferably, the predeterminable proportion of gas in the wax-gas mixture and/or the actual proportion of gas in the wax-gas mixture for the production of contour surfaces is at most 40% volume, particularly at most 30% volume, particularly preferably at most 20% volume.

A further development of the invention provides for the wax formwork production device comprising at least one tool for machining post-processing and the control unit being configured to (i) detect a processing path for a machining post-processing of the wax formwork and (ii) control the tool for machining post-processing such that machining post-processing of the wax formwork is carried out. Machining post-processing can be carried out by milling, turning, drilling, grinding, cutting, eroding, honing and/or lapping. A milling cutter, a drill, a grinding disc, a reamer or similar can be provided as a tool for machining post-processing. The post-processing preferably causes a deviation of the wax formwork from a target model to be reduced and/or a deviating feature of the wax formwork to be added and/or amended.

According to a second aspect, the invention solves the problem by way of a concrete casting manufacturing facility with a wax formwork production device according to the invention and a concrete feed device for casting concrete into the wax formwork. The distance of the wax formwork production device from the concrete feed device is preferably at most 10 km, particularly preferably at most 1 km.

According to a further aspect, the invention solves the problem by way of a method for producing a wax formwork for concrete casting comprising the steps: (a) tempering the wax in a melting unit to a target temperature that is above a solidification temperature of the wax, (b) mixing gas into the wax in a mixing unit, resulting in a wax-gas mixture, and (c) applying the wax-gas mixture in layers to a substrate, such that the wax formwork is created. The layer-by-layer application of the wax-gas mixture onto the substrate is preferably automatic. Tempering is understood to mean heating, cooling or a combination of heating and cooling. For example, it may be advantageous to initially heat the wax and/or the wax-gas mixture in a melting unit to a predeterminable temperature above a solidification temperature of the wax and to subsequently cool the wax and/or the wax-gas mixture, wherein the temperature of the wax and/or the temperature of the wax-gas mixture does not fall below the solidification temperature of the wax.

The method preferably comprises the further step: adding fillers, in particular mineral fillers, into the wax and/or the wax-gas mixture.

A further development of the invention envisages that the adding of gas into the wax occurs simultaneously to the tempering of the wax. Simultaneously means that gas is also added to the wax at at least one point in time during tempering. Preferably, the wax is tempered at least half of the times at which gas is added to the wax. Alternatively or additionally, the gas can also be added before and/or after tempering the wax.

The method preferably comprises the additional step: scraping the wax-gas mixture from a tempering surface of the mixing unit using a scraping element. The tempering surface is a tempered surface of the mixing unit. The scraping element serves to scrape the wax-gas mixture from the tempering surface of the mixing chamber and may be designed, for example, as an agitator arm.

An application temperature of the wax-gas mixture during application of the wax-gas mixture to the substrate is preferably at most 35 °C, preferably at most 20 °C, especially preferably at most 10 °C, particularly preferably at most 5 °C, most preferably at most 2 °C below the solidification temperature of the wax. An application temperature below the solidification temperature of the wax ensures that the wax-gas mixture exhibits sufficient stability. Alternatively or additionally, the application temperature of the wax-gas mixture during application of the wax-gas mixture to the substrate is at most 10 °C, preferably at most 5 °C, especially preferably at most 2 °C above the solidification temperature of the wax. An application temperature above the solidification temperature of the wax can be advantageous in particular for improving the flow capacity and/or the adhesive properties of the wax-gas mixture during application. It is advantageous for the application temperature of the wax-gas mixture to deviate as little as possible from the solidification temperature of the wax, as this minimizes the shrinkage of the wax-gas mixture after application and thus also the distortion of the wax formwork. The application temperature can assume different values as different locations and/or at different points in time, meaning that, particularly during the production process, the application temperature is sometimes above the solidification temperature and sometimes below the solidification temperature.

In a further development of the invention, the method comprises the additional step: machining the wax formwork by milling, turning, drilling, grinding, cutting, eroding, honing and/or lapping. A target model preferably contains a predeterminable model of the wax formwork with all the features and dimensions and, where applicable, information on the surface finishes of certain surfaces.

The target model of the wax formwork is preferably made available on a digital memory. The digital memory may be a hard drive, a USB stick, a memory card, a server or similar. Preferably, a control unit is configured to read said target model and to generate a path of movement for machining post-processing, thus reducing the deviation of the wax formwork from the target model and/or adding and/or amending a deviating feature of the wax formwork. Alternatively or additionally, the target model itself contains a path of movement for machining post-processing. Deviating features are features that distinguish the wax mold from the target model before post-processing, for example holes, threads, fits, dimensional deviations or specified surface finishes. The machining may also serve to smooth a surface, especially a contour surface.

The method preferably comprises the additional steps: (a) cooling the wax formwork to a room temperature and (b) heat-treating at least one surface by post-curing.

Room temperature refers to the temperature of a room in which the wax formwork is cooling. The room temperature is preferably above 15 °C and below 25 °C. Cooling can be both active and passive. For example, cooling can be carried out with the support of the ambient air, water, another fluid and/or using fans and/or coolant. Post-curing is understood to mean that the wax formwork is heated after cooling to a tempering temperature which approximately corresponds to the glass transition temperature of the wax. This increases the crystallinity of the wax formwork. Preferably, the deviation of the post-curing temperature from the glass transition temperature of the wax is at most 10 °C, preferably at most 5 °C, particularly preferably at most 2 °C.

A further development of the invention provides for the coating of at least one surface. Coating can, for example, improve the surface finish and/or the hardness of the wax formwork. Plastic coatings with glass fiber reinforced plastic and/or polyurethane are especially well-suited for this purpose.

According to a further aspect, the invention solves the problem by way of a method for producing a concrete component comprising the steps: (a) producing a wax formwork with the method according to the invention for producing a wax formwork for concrete casting, and (b) filling the wax formwork with concrete, such that a concrete component is created.

A further development of the invention provides for the melting out of a displacer of the wax formwork from the concrete component. A displacer is understood to mean a partial structure of the wax formwork that is largely enclosed within the concrete component after concrete casting.

The method preferably comprises the further steps: (a) separating the wax formwork from the concrete component, and (b) re-filling the wax formwork with concrete, such that a further concrete component is created. Preferably, the wax formwork can therefore be used to produce multiple concrete components, which preferably exhibit consistent dimensional accuracy. Alternatively or additionally, the wax formwork can be melted down and/or the wax of the wax formwork used as starter material for the production of a new wax formwork. This new wax formwork may exhibit the same or different geometry to the previous wax formwork. There is also the option of using a wax and/or a wax mixture during the production of a wax formwork that contains a certain proportion of recycled wax. Recycled wax is wax that has already been used to produce a wax formwork. Separation is understood to mean the destruction-free removal of the wax formwork or a part of the wax formwork from the concrete component.

In particular, the method described above and the device can also be used to produce prototypes, unique models and/or small batches. In particular, it can be provided for that negatives are used as a wax formwork for producing prototypes, unique models and/or small batches. In other words, it can be provided for that a so-called negative is produced as a wax formwork by means of the method and the device. In this case, the production of the prototype, unique model and/or small batch is carried out on the basis of the negative as a wax formwork. The method is also suitable for the production of 1:1 scale prototypes as positives. This means that the prototype is directly produced by way of the method or the device. The method is especially suitable for the production of 1:1 scale prototypes. Such prototype production can be used particularly in the fields of aerospace, the automotive industry, ship and boat building for individual components and hull construction and/or in the packaging industry for molding as a negative model for cardboard mesh. This list is not to be considered exhaustive.

Furthermore, in addition to the production of formwork for concrete components, the method and device described above can also be used for the production of formwork for elastomers, clay, mycelia, aerogels, resins (epoxy resin, polyurethane resin, polyester resin), silicone rubber, gypsum, plastics, ceramics, biopolymers, bacterial biocements and/or cardboard mesh. This list is not to be considered exhaustive.

Furthermore, the method described above and the device can also be used to produce repair or replacement parts. It can be provided for that the method and/or the device are used in manual operation. This means that at least the nozzle is controlled manually. For example, the position of the nozzle is adjusted manually. It is also conceivable that the nozzle is moved manually during the extrusion of the wax-gas mixture and the area to be applied is specified manually. This has the advantage that the device and/or the method can also be used to repair or correct defects. This has the particular advantage that the surface to be repaired does not have to be taught and a route to be travelled must be specified based on the surface. In particular, defects and/or flaking of the wax formwork can be repaired in this way.

Furthermore, it can be provided for that the device has a displacement unit. The displacement unit can introduce a displacer into the area to be printed in a step that takes place either before the wax-gas mixture is extruded or during the extrusion of the wax-gas mixture. The displacer means that no wax-gas mixture can be extruded in a space formed by the displacer and/or an expansion of the extruded wax-gas mixture into the space can be prevented. In particular, it can be provided for that the displacer is removable. It is preferably provided for that the displacer can be removed by heating. In this case, it is advantageous if the displacer can be removed free from residues. For example, it can be provided for that the displacer evaporates upon heating and the resulting gases diffuse through the concrete or the material cast in the wax component. In particular, it is provided for that the wax mold with the displacers is printed first and then the material is cast into the wax mold. It may be envisaged that the displacer and/or displacers is/are removed after the material has been cast in the mold.

This has the advantage that, by inserting displacers, material can be saved as the displacers form a cavity. Furthermore, the displacers can also be introduced in such a way that the space for installation parts, such as lines, power cables, sockets or similar, can be kept clear. This list is not to be considered exhaustive.

In the combination of 3D printing technologies and the precast concrete industry, displacers can be printed from the wax-gas mixture, which are prefabricated before concrete 3D printing or are also printed in the 3D printing process at the same time as the concrete printing.

These displacers can be introduced into concrete components where no concrete is required from a structural point of view in order to save concrete material.

In both cases, the wax is melted out of the concrete component where possible, creating a cavity that can then be used for installation parts.

For example, removal can be achieved by melting. It would also be conceivable that the displacers are formed by a biodegradable material. The displacers can also be etched out.

It would be conceivable to use wax foam inside a concrete component to absorb vibrations. In particular, it can be provided for that a further body is arranged inside the displacer in the space formed by the displacer. In this case, the displacer may be made of a material which can be selectively removed such that only the displacer, but not the vibration body inside the displacer, is removed. For example, the vibration body in the displacer may be made of concrete and/or the wax foam is left in the concrete component as a vibration body to absorb vibrations. The vibration body may be in the shape of a sphere, for example, but is not limited to this. These vibration bodies could absorb vibrations in particular. It would be conceivable to use such vibration bodies in components that are used in earthquake zones.

In the following, the invention will be explained in more detail with the aid of the accompanying drawings. They show:

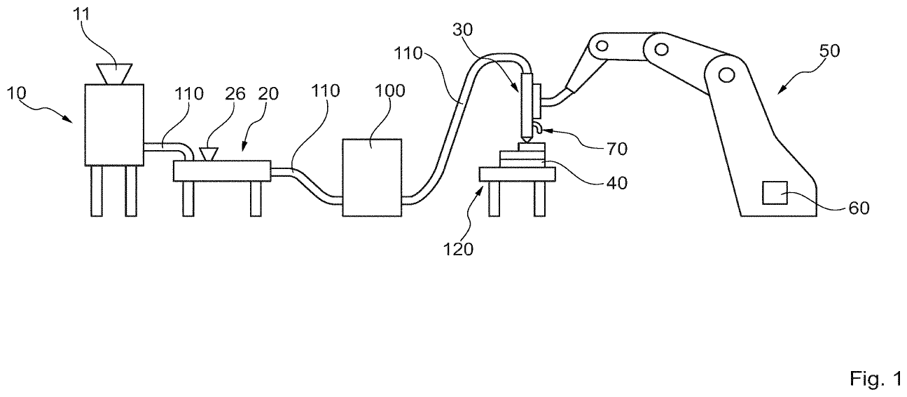

FIG. 1 a schematic view of a wax formwork production device according to the invention for producing a wax formwork for concrete casting,

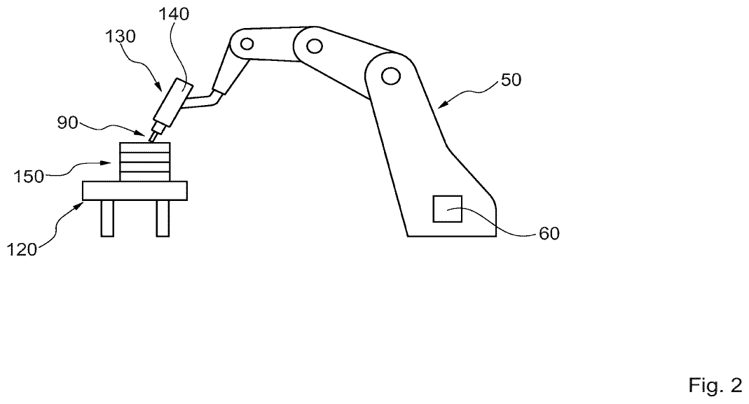

FIG. 2 a schematic view of a positioning system of a wax formwork production device with a tool for machining post-processing,

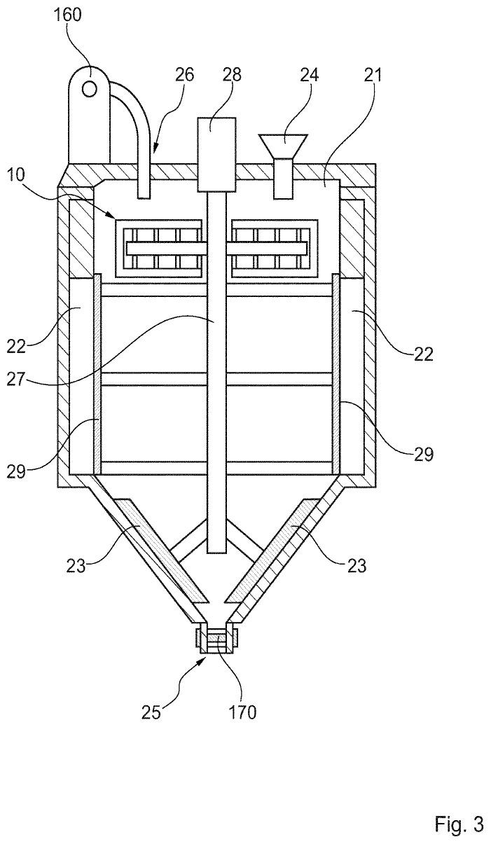

FIG. 3 a schematic view of a partial section of an embodiment of a mixing unit in a wax formwork production device, and

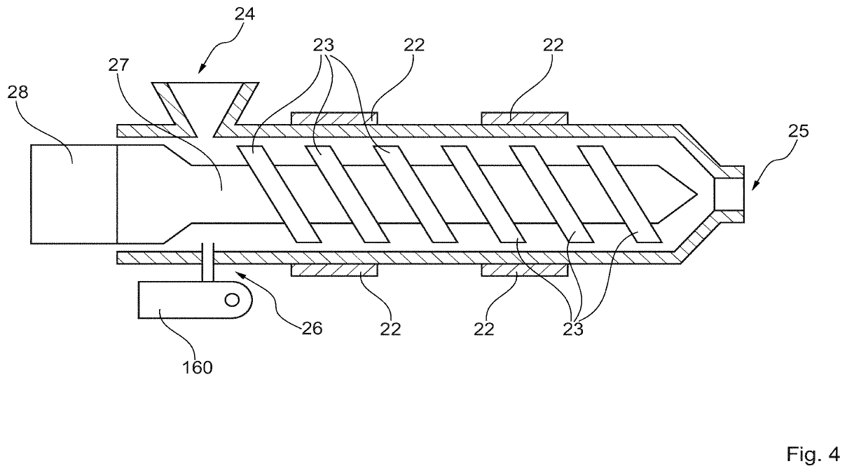

FIG. 4 a schematic view of a partial section of a further embodiment of a mixing unit in a wax formwork production device.

FIG. 1 shows a schematic view of a wax formwork production device according to the invention comprising a melting unit 10, a mixing unit 20, a nozzle 30 and a positioning system 50. The melting unit 10 has a wax inlet 11 on its upper side via which wax can be fed to the melting unit 10.

There is a heating element, not shown, in the melting unit 10, for example in the form of a heating cartridge, a heating band, a heat exchanger, a continuous flow heater, a heating medium, an immersion heater or similar. In the melting unit 10 the wax is heated to a predeterminable temperature above the solidification temperature of the wax. It is then transported to the mixing unit 20 via a conveyor tube 110. The melting unit 20 has a gas inlet 26 via which a gas can be fed to the mixing unit 20. A gas can be a gas, particularly carbon dioxide, or a gas mixture, particularly air. The gas is mixed into the wax in the mixing unit 20, resulting in a wax-gas mixture.

The wax-gas mixture is transported via a conveyor tube 110 from the mixing unit 20 to a conveyor device 100. The conveyor device 100 may be designed as a pump, extruder or compressor. The wax-gas mixture is transported via a further conveyor tube 110 from the conveyor device 100 to a nozzle 30. The wax-gas mixture is applied to a substrate in layers through the nozzle, creating a wax formwork.

It may also be provided for that the conveyor device 100 is arranged between the conveyor tube 110 and the gas inlet 26. In particular, it may be envisaged that the conveyor device 100 forms part of the mixing unit 20.

The substrate can be either a base plate 120, deposited wax-gas mixture 40 or a base body to be printed onto. The nozzle 30 is arranged on a positioning system 50, which is designed as a robot in the embodiment shown. In the embodiment shown, the positioning system 50 comprises a control unit 60 that is configured to control the positioning system 50 for positioning the nozzle 30 relative to the substrate such that a wax formwork is created. The control unit 60 may also be designed as a separate component and connected to the positioning system 50 via a control line or transmitter-receiver devices, which are arranged both in the control unit 60 and in the positioning system 50 and are wirelessly connected to each other.

The control unit 60 can be connected to the mixing unit 20, for example via a control line or transmitter-receiver devices, which are arranged both in the control unit 60 and in the mixing unit 50 and are wirelessly connected to each other. The transmitter-receiver device of the mixing unit 20 can be connected to a sensor, not shown, in the mixing unit 20, which can in particular detect a gas content of the wax-gas mixture in the mixing unit 20, and transmit the sensor data of the sensor to the control unit 60.

The control unit 60 can control the mixing unit 30 as a function of the sensor data such that a wax-gas mixture with a proportion of gas corresponding to the target proportion of gas forms when gas is added to the wax. The control unit 60 may be connected to the melting unit 10 and configured to control the melting unit 10 to heat the wax to a predeterminable temperature above a solidification temperature of the wax.

A cooling and heating device 70 in the form of a tube with an outlet opening through which air flows is arranged on the nozzle. The cooling and heating device 70 serves to cool and/or heat deposited wax-gas mixture 40. Depending on whether the deposited wax-gas mixture 40 is to be cooled or heated, the cooling and heating device 70 is fed with cold or hot air.

FIG. 2 shows a schematic view of a positioning system 50. The positioning system 50 is again designed as a robot and has a control unit 60. A wax formwork 150 is arranged on a base plate 120. A milling head 130 with a tool drive 140 and a tool for machining post-processing 90 in the form of a milling cutter is arranged on the positioning system 50. Instead of a milling cutter, a drill, reamer or similar tool can also be used for machining post-processing 90.

The tool for machining post-processing 90 is driven by the tool drive 140. The tool drive 140 is connected to the control unit 60 via a control line or transmitter-receiver devices, which are arranged in the control unit 60 in the tool drive 140 and are wirelessly connected to each other. The control unit 60 is configured to detect a processing path for machining post-processing and to control the tool for machining post-processing 90 such that machining post-processing of the wax formwork 150 occurs.

In order to detect the processing path, the control unit 60 can read a target model of the wax formwork, wherein said model can also be made available to a digital memory, not depicted. The target model contains a predetermined model of the wax formwork 150 with all the features and dimensions and, where applicable, information on the surface finishes of certain surfaces of the wax formwork 150. The machining post-processing of the wax formwork 150 causes a deviation of the wax formwork 150 from a target model to be reduced and/or a deviating feature of the wax formwork 150 to be added and/or amended.

FIG. 3 depicts a schematic view of a partial section of an embodiment of a mixing unit 20 in a wax formwork production device. The mixing unit comprises a mixing chamber 21 which is rotationally symmetrical in the embodiment shown and consists of an upper cylindrical part and a lower conically tapered part. A tempering device 22 is arranged the upper cylindrical part, which surrounds the mixing chamber 21 and forms a tempering surface which is part of the outer wall of the mixing chamber 21.

The outer wall of the mixing chamber 21 is also the scraping wall. An inlet 24 and a gas inlet 26 are arranged on the upper side of the mixing chamber 21. As an alternative, the inlet 24 and the gas inlet 26 may also be arranged on the side of the mixing chamber 21. Wax or previously heated wax is fed to the mixing chamber 21 via the inlet 24.

A fan 160 is fluidically connected to the gas inlet 26 and feeds gas to the mixing chamber 21 via the gas inlet 26. As an alternative to a fan 160, a gas compressor or a pressure vessel with a compressed gas can also be provided.

A shaft 27 is arranged centrally in the mixing chamber, said shaft being mounted such that it can be rotated about an axis of rotation and being driven by a mixing motor 28. A melting unit 10 with multiple heating filaments is arranged on the shaft 27. The melting unit 10 heats the wax entering the mixing chamber 21 to a predeterminable temperature above a solidification temperature of the wax. A mixing element 29 is arranged on the shaft 27 below the melting unit 10. When the shaft 27 rotates about the axis of rotation, the mixing element 29 mixes the gas into the wax, resulting in a wax-gas mixture.

A scraping element 23 is arranged on the shaft below the mixing unit 29. When the shaft 27 rotates about the axis of rotation, the scraping element 23 scrapes the wax-gas mixture from the outer wall of the mixing chamber 21. As a result, the wax-gas mixture is conveyed to the outlet nozzle 25. The outlet nozzle 25 is arranged downstream of the mixing unit 20 in the direction of flow and fixed to the mixing unit 20. A valve 170 is arranged on the outlet nozzle 25. The valve 170 can be controllable; in particular, it can be controlled by the control unit 60.

FIG. 4 depicts a schematic view of a partial section of a further embodiment of a mixing unit 20 in a wax formwork production device. Here, the mixing unit 20 is designed as an extruder. The mixing unit 20 comprises a mixing chamber 21 with a cylindrical part and a conical part. A shaft 27 in the form of an extruder screw is arranged centrally in the mixing chamber 21. The shaft 27 is driven by a mixing motor 28, which is arranged on the shaft 27.

An outlet nozzle 25 is arranged downstream of the mixing unit 20 in the direction of flow, said nozzle being fixed to the mixing unit 20. On the opposite side to the outlet nozzle 25, the mixing unit 20 has an inlet 24 on its upper side and a gas inlet 26 on its lower side. Alternatively, the inlet 24 can be arranged on the side or on the lower side and/or the gas inlet 26 can be arranged on the upper side or on the side of the mixing unit. Wax or previously heated wax is fed to the mixing chamber 21 via the inlet 24. A fan 160 is fluidically connected to the gas inlet 26 and feeds gas to the mixing chamber 21 via the gas inlet 26. As an alternative to a fan 160, a gas compressor or a pressure vessel with a compressed gas can also be provided, via which gas is fed to the mixing chamber 21.

On the outside of the cylinder, the mixing unit 20 has two tempering devices 22 in the form of heating bands. At the same time, the tempering device 22 may also form the melting unit 10, meaning that no separate melting unit is necessary. The thread leads of the shaft 27, which is designed as an extruder screw, are the scraping elements 23. When the shaft 27 is rotated by the mixing motor 28, the scraping elements 23 scrape the wax-gas mixture from the outer wall of the mixing chamber 21 and transport it towards the outlet nozzle 25. The outer wall of the mixing chamber 21 is thus the scraping wall.

### REFERENCE LIST

10 melting unit
11 wax inlet
20 mixing unit
21 mixing chamber
22 tempering device
23 scraping element
24 inlet
25 outlet nozzle
26 gas inlet
27 shaft
28 mixing motor
29 mixing element
30 nozzle
40 deposited wax-gas mixture
50 positioning system
60 control unit
70 cooling and heating device
90 tool for machining post-processing
100 conveyor device
110 conveyor tube
120 base plate
130 milling head
140 tool drive
150 wax formwork
160 fan
170 valve

1. A wax formwork production device for producing a shaping wax formwork as a negative for producing a casting as a positive, comprising:
(a) a melting unit for heating a wax to a predeterminable temperature above a solidification temperature of the wax,
(b) a mixing unit configured to mix gas into the wax, resulting in a wax-gas mixture,
(c) a nozzle arranged downstream of the mixing unit in a direction of flow, wherein the nozzle is configured to apply the wax-gas mixture in layers to a substrate,
(d) a positioning system for positioning the nozzle relative to the substrate, and
(e) a control unit configured to control the positioning system for positioning the nozzle relative to the substrate such that a the shaping wax formwork is created, wherein the melting unit is arranged in the mixing unit on a shaft mounted rotatably about an axis of rotation, wherein the shaft is driven by a mixing motor.

2. The wax formwork production device according to claim 1, wherein the control unit is configured to adjust a mass flow of the nozzle.

3. The wax formwork production device according to claim 1, wherein the mixing unit comprises
(a) a mixing chamber with a tempering surface and a scraping wall,
(b) a tempering device configured to temper the tempering surface to a tempering temperature such that the wax-gas mixture is tempered on the tempering surface of the mixing chamber, and
(c) a scraping element for scraping the wax-gas mixture from the scraping wall of the mixing chamber and/or from the tempering surface of the mixing chamber.

4. The wax formwork production device according to claim 1 further comprising
(a) a cooler arranged to cool a previously deposited wax-gas mixture, and/or
(b) a heating device arranged to heat the previously deposited wax-gas mixture, and
(c) wherein the mixing unit is configured to add a predeterminable proportion of gas to the wax.

5. The wax formwork production device according to claim 4, wherein the control unit is configured to automatically carry out a method comprising:
(a) detecting a target proportion of gas,
(b) controlling the mixing unit such that a wax-gas mixture with a proportion of gas corresponding to the target proportion of gas forms when gas is added to the wax.

6. The wax formwork production device according to claim 1, further comprising
a. at least one tool for machining post-processing, and
b. wherein the control unit is configured
i. to detect a processing path for machining post-processing of the wax formwork, and
ii. to control the tool for machining post-processing such that machining post-processing of the wax formwork takes place.

7. A casting production facility, comprising:
a. a wax formwork production device according to claim 1, and
b. a casting material feed device for casting the casting material into the wax formwork.

8. A method for producing a shaping wax formwork as a negative for producing a casting as a positive, comprising:
introducing wax into a melting unit;
tempering the wax in the melting unit to a target temperature above a solidification temperature of the wax;
mixing gas into the wax in a mixing unit, resulting in a wax-gas mixture; and
applying the wax-gas mixture in layers to a substrate, such that the wax formwork is created.

9. The method according to claim 8, wherein
an application temperature of the wax-gas mixture during application of the wax-gas mixture to the substrate is at most 35 °C, below a solidification temperature of the wax.

10. A method for producing a casting, comprising:
producing a wax formwork using a method according to claim 8, and
filling the wax formwork with casting material, such that a casting is created.

11. The method according to claim 8 further comprising detecting a target proportion of gas and forming the wax-gas mixture with a proportion of gas corresponding to the target proportion of gas when gas is added to the wax.

12. A method according to claim 8 wherein an application temperature of the wax-gas mixture during application of the wax-gas mixture to the substrate is at most 10 °C below a solidification temperature of the wax.

13. A method according to claim 8 wherein an application temperature of the wax-gas mixture during application of the wax-gas mixture to the substrate is at most 5 °C below a solidification temperature of the wax.

14. A method according to claim 8 wherein an application temperature of the wax-gas mixture during application of the wax-gas mixture to the substrate is at most 2 °C below a solidification temperature of the wax.
